(19) United States
(12) Patent Application Publication
(10) Pub. No.: US 2010/0301845 A1
(43) Pub. Date: Dec. 2, 2010

(54) ABSOLUTE MEASUREMENT STEERING ANGLE SENSOR ARRANGEMENT

(75) Inventor: Heinrich Acker, Schwalbach (DE)

Correspondence Address: RATNERPRESTIA, P.O. BOX 980, VALLEY FORGE, PA, 19482, US

(73) Assignee: CONTINTENTAL TEVES AG & CO. OHG, Frankfurt (DE)

(21) Appl. No.: 12/745,066

(22) PCT Filed: Dec. 1, 2008
(86) PCT No.: PCT/EP08/66565

§ 371 Date: May 27, 2010

(30) Foreign Application Priority Data
Nov. 30, 2007 (DE) 10 2007 058 122.1
Dec. 1, 2008 (DE) 10 2008 059 775.9

(51) Int. Cl. G01B 7/30

(52) U.S. Cl. 324/207.25

(57) ABSTRACT

An angle sensor arrangement for measuring the rotational angle of a shaft comprising a first gearwheel and a first magnetic encoder with at least one encoder track. The first gearwheel and the first magnetic encoder rotate with shaft. The angle sensor arrangement also comprises a second gearwheel and a second magnetic encoder with at least one encoder track. The second encoder rotates with the second gearwheel, and the first and second gearwheels interact. At least one magnetic field sensor element is assigned to the first encoder and to the second encoder, respectively and the first and second gearwheels are embodied in terms of their common transmission ratio and the first and second magnetic encoders are embodied in terms of their pole numbers.

### CROSS REFERENCE TO RELATED APPLICATIONS

This application is the U.S. national phase application of PCT International Application No. PCT/EP2008/066565, filed Dec. 1, 2008, which claims priority to German Patent Application No. 10 2008 059 775.9, filed Dec. 1, 2008 and German Patent Application No. 10 2007 058 122.1, filed Nov. 30, 2007, the contents of such applications being incorporated by reference herein.

### FIELD OF THE INVENTION

The invention relates to an angle sensor arrangement for measuring the rotational angle of a shaft and to the use of the angle sensor arrangement in motor vehicles.

### BACKGROUND OF THE INVENTION

Document DE 10 2004 004 025 A1, which is incorporated by reference, proposes a steering angle sensor having a first and a second gearwheel, on each of which a magnetic encoder is arranged, wherein the first gearwheel rotates with a steering shaft. A magnetic field sensor element is assigned to each of these encoders, from the output signals of which magnetic field sensor elements the absolute steering angle is determined by applying the Nonius principle.

The invention relates to the object of proposing an angle sensor arrangement which permits relatively high precision of the detection of the absolute rotational angle.

### SUMMARY OF THE INVENTION

At least one object is achieved according to aspects of the invention by means of an angle sensor arrangement for measuring the rotational angle of a shaft.

An inventive embodiment of the angle sensor arrangement permits the Nonius principle to be utilized with increased or optimum effect.

A magnetic field sensor element is preferably understood to be a magneto-electric transducer element, such as an AMR element, a GMR element, some other magneto-resistive sensor element or a Hall element. At least one of the magnetic field sensor elements, in particular all of the magnetic field sensor elements, may be embodied as an AMR sensor element with two bridge structures or as a double Hall element or as a Hall element with an integrated yoke and evaluation circuit for measuring two magnetic field components. Such magnetic field sensor elements may be combined or used in combination.

When at least one AMR magnetic field sensor element is used, a respectively detected pole expediently corresponds to one period of the magnetic field sensor element output signal, and in the case of at least one GMR magnetic field sensor element a respectively detected pole pair corresponds to one period of the magnetic field sensor element output signal.

The at least one magnetic field sensor element may have two outputs which make available, in particular, an essentially sinusoidal output signal and an essentially cosinusoidal output signal, wherein these output signals are preferably correspondingly phase-shifted with respect to one another through, essentially, 90°.

At least one or more or all of the magnetic field sensor elements may have an integrated electronic signal processing circuit which determine, in particular, a rotational angle within a pole/pole pair or within one period of the assigned encoder or make available the field angle of the detected magnetic field and on the output side.

The magnetic field sensor elements may be connected directly or indirectly to an electronic control unit which is integrated, in particular, into the angle sensor arrangement, wherein the electronic control unit is embodied in such a way that the absolute rotational angle within the rotational angle measuring range is determined directly or indirectly from the magnetic field sensor element output signals. The electronic control unit may comprise a bus node for additional sensor arrangements. The electronic control unit may comprise at least one microprocessor or microcontroller.

The electronic control unit is preferably connected to an additional electronic control unit of a motor vehicle brake system which accesses the determined rotational angle of the angle sensor arrangement and has, in particular, additional control systems.

The electronic control unit expediently comprises at least one analog/digital converter and/or at least one sine digital converter, in particular if the magnetic field sensor elements themselves do not comprise an integrated analog/digital converter.

The first magnetic encoder is preferably attached to the first gearwheel, in particular concentrically, and the second magnetic encoder is expediently attached, in particular concentrically, to the second gearwheel.

The first magnetic encoder may be embodied as a multipole encoder, and the second magnetic encoder may be embodied as a dipole encoder.

At least one gearwheel is preferably of essentially circular design.

The teeth of the first gearwheel and those of the second gearwheel expediently engage in one another.

The first and second gearwheels expediently form a transmission stage.

The angle sensor arrangement preferably comprises a signal processing unit with at least two signal processing channels, wherein the at least one magnetic field sensor element, which is assigned to the first encoder, is connected to a first signal processing channel, and the at least one magnetic field sensor element, which is assigned to the second encoder, is connected to a second signal processing channel, wherein the two signal processing channels are connected on the output side to a multiplexer which is itself connected to an analog/digital converter which is connected on the output side to a calculation unit which calculates in each case a rotational angle of the detected magnetic field of a pole/pole pair/period of the first and second encoders, and/or calculates the absolute rotational angle of the shaft from these rotational angles.

It is expedient that the signal processing unit has at least two signal processing channels, each of which is assigned to at least one magnetic field sensor element, or wherein a separate signal processing channel is assigned to each of the, for example two or four, magnetic field sensor elements, wherein each of the signal processing channels has a signal amplifier unit and/or an analog/digital converter and/or a sine digital converter. In particular, two or more of the signal processing channels are connected on the output side to a multiplexer which transmits the signals to a common analog/digital converter or to the electronic control unit.

The signal processing unit and/or the at least one multiplexer and/or the at least one analog/digital converter and/or the calculation unit are preferably embodied on a common chip and/or integrated into the electronic control unit.

The first and second gearwheels are preferably embodied in terms of their common transmission ratio, and the first and second magnetic encoders are preferably embodied in terms of their pole numbers/pole pair numbers, in such a way that Δ is assigned a value greater than 0 and less than 0.5, in particular a value greater than 0 and less than 0.04.

The first and second gearwheels are expediently embodied in terms of their common transmission ratio, and the first and second magnetic encoders are expediently embodied in terms of their pole numbers or pole pair numbers, in such a way that n is assigned a value between 8 and 60, and in particular a value between 14 and 40.

The first magnetic encoder is preferably of annular design or embodied as a hollow cylinder so that it does not have to be arranged or mounted at the end of the shaft.

The first and second gearwheels preferably each have an oblique toothing for more uniform operation of the transmission, and/or the angle sensor arrangement has a third gearwheel which is arranged essentially coaxially with respect to the second gearwheel and, together with the second gearwheel, is meshed with the first gearwheel by means of a spring bias, as a result of which the transmission play between the gearwheels can be reduced or eliminated.

The magnetic field sensor elements are expediently arranged essentially in a common plane in terms of their respective sensitive main plane. In particular, these magnetic field sensor elements are integrated in/on a common chip or are arranged on a common printed circuit board, which is relatively inexpensive.

The angle sensor arrangement preferably has a housing which is of an at least partially magnetically screening design. This is advantageous or beneficial in particular in the case of a relatively compact design of the angle sensor arrangement.

The rotational angle measuring range is preferably more than 360° and less than 2160°. Here, the rotational angle measuring range depends, in particular, on the maximum steering range of the steering of a motor vehicle, wherein the steering range is particularly preferably 4 to 6 steering revolutions.

The angle sensor arrangement is preferably of redundant design by virtue of the fact that at least two magnetic field sensor elements are respectively assigned to the first and the second magnetic encoders, as a result of which it is possible to compensate for the failure of a magnetic field sensor element or of one magnetic field sensor element per encoder, and the operation of the angle sensor arrangement can nevertheless be maintained. In particular, the angle sensor arrangement has, for further increasing its own reliability or operational reliability, at least four separate measuring channels which are each assigned one of the magnetic field sensor elements. The electronic control unit and/or the signal processing unit are expediently embodied in such a way that they detect failure of at least one magnetic field sensor element and/or at least one measuring channel and particularly preferably make available a warning information item relating thereto.

The first and/or second magnetic encoders may be embodied in such a way that the magnetization directions of areas within at least one of the poles change essentially continuously and/or monotonously and/or in a continuously progressive fashion along the encoder track. The respective change in the magnetization directions of adjacent areas of one or more poles along the encoder track is embodied, in particular, essentially linear here with respect to a corresponding change in travel length along the encoder track. This already results in an essentially linear relationship between the field angle or detectable magnetic field and measuring variable or relative position between the encoder and a magnetic field sensor element at the surface of the encoder. For this reason, when such a magnetic encoder is used in a sensor arrangement for detecting the field angle/field direction, the reading distance or air gap between the encoder and magnetic field sensor element can be kept relatively short, that is to say can be kept significantly smaller than half a pole length. Furthermore, for this reason only a relatively small material strength of the encoder is required, which permits a reduction in cost, and the immunity to interference or the signal-to-noise ratio of the sensor arrangement is also improved by the short air gap length which can now be applied.

The encoder track preferably extends in a measuring direction or a magnetically impressed scale of the encoder and/or is expediently composed of the successive poles.

The magnetic encoder is expediently embodied as a permanent magnet made of hard-magnetic material.

The magnetization direction preferably relates to the profile direction of the encoder track, that is to say the magnetization direction is, in particular, always related to a tangent with respect to the encoder track, within tangent is positioned in the respective area.

The poles of the magnetic encoder are preferably not magnetized in the manner of blocks and/or homogeneously.

A pole/pole pair, which can be detected by a magnetic field sensor element, of the first or second magnetic encoder is also preferably understood to be a period.

The magnetization directions of the areas within two successive pole lengths along the encoder track are preferably embodied in such a way that these magnetization directions essentially model a rotation through 360°.

An area is preferably understood to be an area of the one pole or of a plurality of poles or of all the poles which is infinitesimally narrow, in particular strip-shaped, along the encoder track.

In one exemplary embodiment, at least within the areas in a central segment of a pole which comprises 50% of the pole length along the encoder track and is bounded by two edge segments of this pole comprising in each case 25% of the pole length on both sides, the magnetization directions of these areas in the central segment of this pole essentially model a rotation of at least 45°, in particular at least 70°, more particularly 90°±5°, and/or that the magnetization directions of the two outermost areas on both sides of the central segment of this pole are embodied rotated through at least 45°, in particular at least 70°, more particularly 90°±5°, with respect to one another, wherein the magnetization directions are always related to the respective profile direction of the encoder track. The magnetization directions of these areas in the central segment of this pole model may have a rotation of essentially 90°.

The encoder track and/or the encoder are preferably embodied essentially in accordance with one of the following geometric shapes: ring, ring segment, flat cylinder, cuboid, rectangular solid, flat, disk-shaped right parallelepiped, cylinder, long cylinder or half cylinder, divided along the longitudinal axis.

The invention also relates to the use of the angle sensor arrangement as a steering angle sensor arrangement in a motor vehicle.

The angle sensor arrangement according to aspects of the invention may be provided for use in systems in which an absolute rotational angle is to be measured over a rotational angle measuring range of more than 360° multi-turn and a true-power-on functionality, i.e. also directly after activation or re-activation, in particular in relation to the energy supply of the angle sensor arrangement, the measurement/measurability of the absolute rotational angle in terms of the entire rotational angle measuring range is desirable or even absolutely necessary.

### BRIEF DESCRIPTION OF THE DRAWINGS

Further preferred embodiments emerge from the subclaims and the following description of an exemplary embodiment with reference to figures. The invention is best understood from the following detailed description when read in connection with the accompanying drawings. Included in the drawings is the following figures:

FIG. 1 shows an exemplary embodiment of the angle sensor arrangement,

FIG. 2 shows exemplary signal processing of the angle sensor arrangement,

FIGS. 3 a and 3b show the poles/pole pairs detected by the magnetic field sensor elements, in terms of the rotational angle measuring range of the angle sensor arrangement,

FIG. 4 shows an exemplary, annular magnetic encoder according to the prior art,

FIG. 5 shows an exemplary embodiment of an annular encoder with magnetization directions which rotate continuously along the encoder track,

FIG. 6 shows an exemplary graphic illustration of the magnetization direction as a function of the standardized travel length along the encoder track in relation to an encoder with block-like magnetization, and to an encoder with magnetization directions which rotate continuously along the encoder track, and

FIG. 7 shows an exemplary magnetization device.

### DETAILED DESCRIPTION OF THE INVENTION

In the angle sensor arrangement illustrated by way of example in FIG. 1 by means of a cross section, the shaft 1 or steering shaft 1 is surrounded concentrically by the first encoder 4, wherein it is possible to provide structural elements which hold the two parts at a distance from one another. The shaft 1 and first encoder 4 are attached to one another in a rotationally fixed fashion, i.e. through positive locking by means of a modification (not illustrated) of the circular shape of the cross section. The first gearwheel 2 is also attached to the shaft 1 in a rotationally fixed fashion. The first magnetic encoder 4 is embodied, by way of example, as a multipole encoder, and the first gearwheel 2 can be embodied as an integrated component. The housing 8 forms external contours of the steering angle sensor arrangement and surrounds the printed circuit board 9 on which the magnetic field sensor elements 6 and 7 are arranged, wherein the magnetic field sensor element 6 is assigned to the first magnetic encoder 4, and detects the magnetic field thereof or the field direction essentially in the region of one of its poles/pole pairs/periods, and the magnetic field sensor element 7 is correspondingly assigned to the second magnetic encoder 5 which is embodied, by way of example, as a dipole encoder. The second magnetic encoder 5 is connected in a rotationally fixed fashion to a second gearwheel 3, for example by arranging and attaching the second encoder 5 in a cavity (not illustrated) in the second gearwheel 3. The second magnetic encoder 5 and the second gearwheel 3 can alternatively be embodied as a common integrated component. The first and second gearwheels 2, 3 engage in one another and form a transmission stage. The angle sensor arrangement uses, for example, the Nonius principle, wherein in each case one rotational angle per encoder 4, 5 is determined from the field direction, detected by the magnetic field sensor elements 6, 7, in relation to the poles/pole pairs of the respectively assigned encoder 4, 5. In this context, the respectively occurring combinations of rotational angles which can be determined are unique over the entire rotational angle measuring range, after which the absolute rotational angle φ of the shaft 1 is determined with respect to the entire rotational angle measuring range from each rotational angle combination. The number of detectable poles per encoder results from the transmission ratio of the gearwheels 2, 3 and the number of poles of the first and second encoder 4, 5. For example, the first and second gearwheels 2, 3 are embodied with respect to their common transmission ratio, and the first and second magnetic encoders 4, 5 are embodied in terms of their pole numbers, in such a way that the magnetic field sensor element 6, 7 which is assigned to the first or second encoder 4, 5 detects n poles or pole pairs over the entire rotational angle measuring range of the angle sensor arrangement, and the magnetic field sensor element 6, 7 which is assigned to the second or first encoder 5, 4 detects n−1+Δ poles or pole pairs over the entire rotational angle measuring range of the angle sensor arrangement, wherein A is defined as a real number between 0 and 1, and n is defined as a natural number. As a result of this combination, the Nonius principle is utilized particularly effectively, as a result of which particularly high measuring accuracy is made possible.

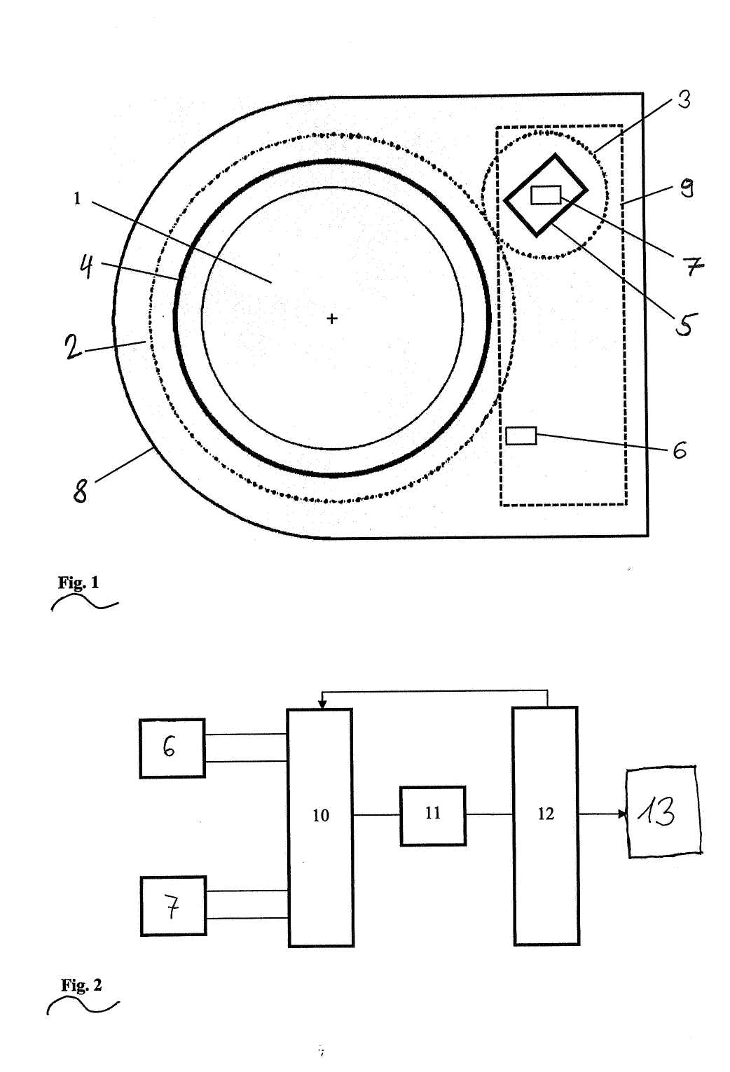

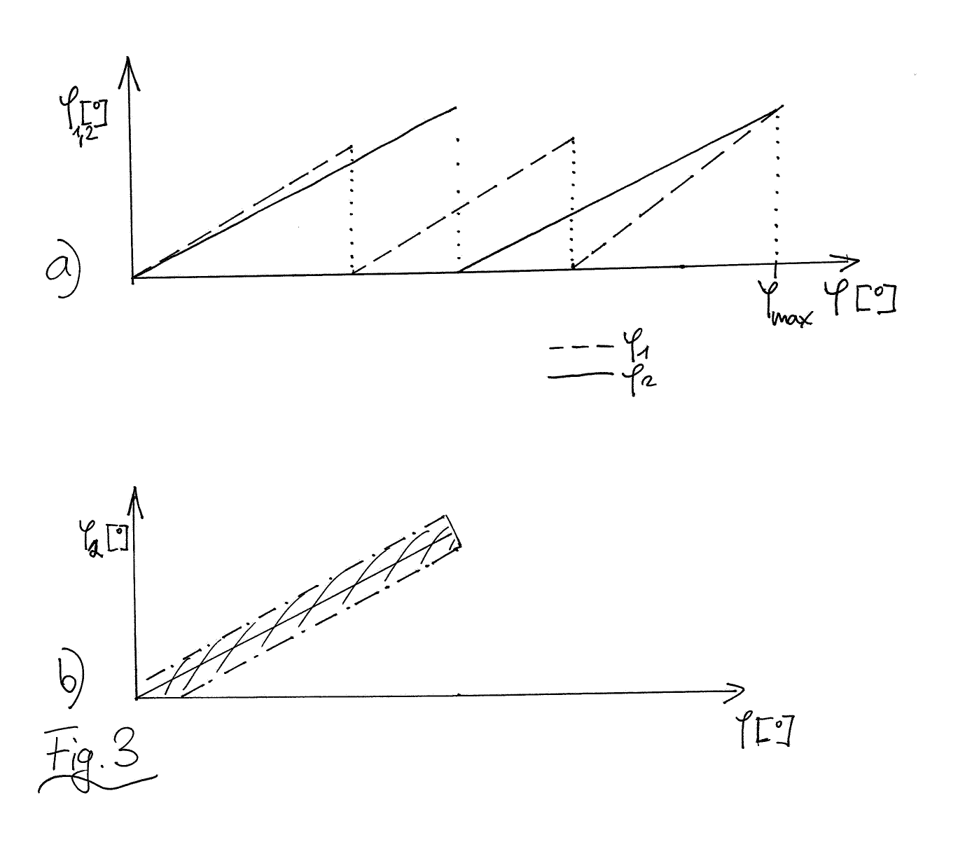

FIG. 2 shows an example of signal processing of the angle sensor arrangement. The output signals of the magnetic field sensor elements 6, 7 are evaluated here by feeding them to a multiplexer 10 which, under the control of the calculation unit 12, transmits in each case one of the magnetic field sensor elements output signals to the analog/digital converter 11 with an integrated signal amplifier unit. The analog/digital converter 11 transmits here its respective digitized output signal to the calculation unit 12. Since, for example, four signals are present, two magnetic field sensor elements with a bridge structure, which generates two output signals in each case, wherein one of these signals is embodied in an essentially sinusoidal shape and the other in a cosinusoidal shape, four signal channels have to be fed to the multiplexer 10, which signal channels are successively selected by the calculation unit 12. The calculation unit 12 therefore receives the necessary information in order to subsequently calculate and output the absolute rotational angle, for example the absolute rotational angle is transmitted to an electronic control unit 13 or made available thereto. This process is repeated cyclically. FIG. 3 illustrates an exemplary configuration of the angle sensor arrangement with which the Nonius principle can be utilized effectively or to an optimum degree. FIG. 3a) shows the angle φ₁ which is detected by a first magnetic field sensor element, the dashed curve, of the first encoder and the angle φ₂ which is detected by a second magnetic field sensor element, the continuous curve, of the second encoder, in each case within the region of two or three pole pairs or periods, and as a function of the rotational angle φ of the shaft, overall related to the defined rotational angle measuring range of the angle sensor arrangement from 0° to a maximum angle φₘₐₓ. With respect to the rotational angle measuring range, the first magnetic field sensor element detects 3 periods, and the second magnetic field sensor element 2 periods.

As is apparent from FIG. 3b), moreover on the one hand a highest possible gradient of the characteristic curve is to be aimed at for a precise measurement, for example for φ₂, continuous curve, since here φ₂ lies within an error band due to measuring inaccuracies and faults of the detected angles. The error band is characterized by hatching and is restricted by two dash-dotted maximum error angle curves. The higher the gradient of the curve, the smaller the degree to which the error band becomes perceptible, as a result of which the signal-to-noise ratio is increased. A steeper curve means the highest possible number of periods which can be detected within the rotational angle measuring range by the respective magnetic field sensor element. However, on the other hand, the number of periods cannot be increased randomly, because inter alia the pole lengths can only be reduced to a limited degree and the external circumference of the encoder track can only be increased to a limited degree for reasons of the desired compactness of the angle sensor arrangement. In addition, the fabrication errors or tolerances have in turn a greater effect on the pole lengths of the magnetic encoders when the pole lengths are relatively short than in the case of large pole lengths.

In the case of a configuration with n to n-1 detectable poles/pole pairs or periods, the maximum steepness of the two curves within an individual angle sensor arrangement in relation to the measuring range is reached independently of the respective pole length.

Accordingly, the two subsystems should moreover expediently have a pole number or period number which moves as close as possible to the structural maximum. This differs essentially from the configuration of previously known angle sensor arrangements in which—partially using the so-called diophantic equations—only the criterion of ambiguity was deposited. The combination of n−1 periods and n periods means coming as close as possible to the structural maximum (n) in both subsystems. A phase shift occurs between the subsystems and causes the modeling of the rotational angle to be unambiguous in the entire measuring range. This measuring range is limited by the criterion n−1 or n because the phase shift at the start of the measuring range is reached precisely again after n−1 or n periods at the end of the measuring range. For this reason, it is, in particular, not optimum to select, for example, n and n−0.4 periods or detectable poles/pole pairs because less than half the possible measuring range is then used.

The angle sensor arrangement is preferably to take up the smallest possible installation space, as a result of which a transmission stage related to the transmission ratio U of the first and second gearwheel where Ü=n/(n−1) does not appear optimum. The minimum diameter of the first gearwheel on the shaft is given by the shaft circumference itself, which often already has a diameter which is large for the aimed-at dimensions of an angle sensor arrangement. Since the value of n can be, for example, 30 or 40, the transmission stage would have a transmission ratio near to 1, which is mechanically problematic. In particular, a second transmission stage is not to be used to solve the problem because this could worsen the problem of transmission tolerances. It is therefore particularly preferred to introduce a combined magnetic-mechanical transmission ratio Ü_{MM}. If the number of poles/pole pairs/periods which can be detected by the respectively assigned magnetic field sensor element corresponds to n or n−1 poles, but the encoders themselves have P₁ and P₂ poles, Ü_{MM}=(P₁/P₂)*((n−1)/n). Ü_{MM} is the factor by which the second gearwheel is smaller, in terms of the toothing, than the first gearwheel, and therefore P₁/P₂ should quite particularly preferably be selected such that the second gearwheel is given a tooth number which is in the vicinity of the minimum for a high operational quality level of the transmission. Numerical example:

n=36, P₁=6, P₂=2

Ü_{MM}=2.91667

possible numerical number combination Ü_{MM}=70/24

The second gearwheel can therefore preferably be relatively small and space-saving, even though the period numbers/poles/pole pairs of the first and second encoders which can be detected by the assigned magnetic field sensor elements over the rotational angle measuring range differ by only one. It is therefore particularly advantageous to equip the smaller, second gearwheel with a single magnet (P₂=2), which, moreover, can be manufactured significantly more economically than a multipole encoder. On the other hand, the first gearwheel should advantageously be coupled to an annular multipole encoder as the first encoder, so that the angle sensor arrangement can be used not only on a shaft end but also with a plug-through shaft. An annular structure of the first encoder is unavoidable for this. The ring could in principle however, also have only two poles.

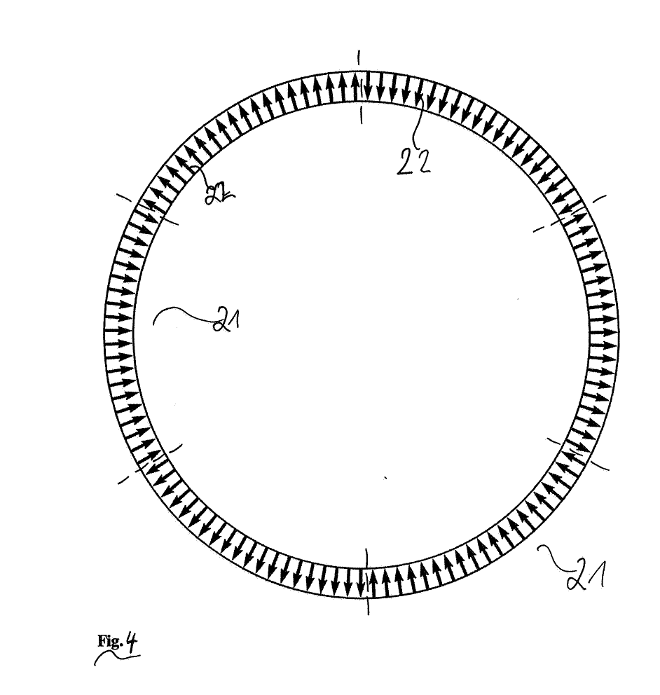

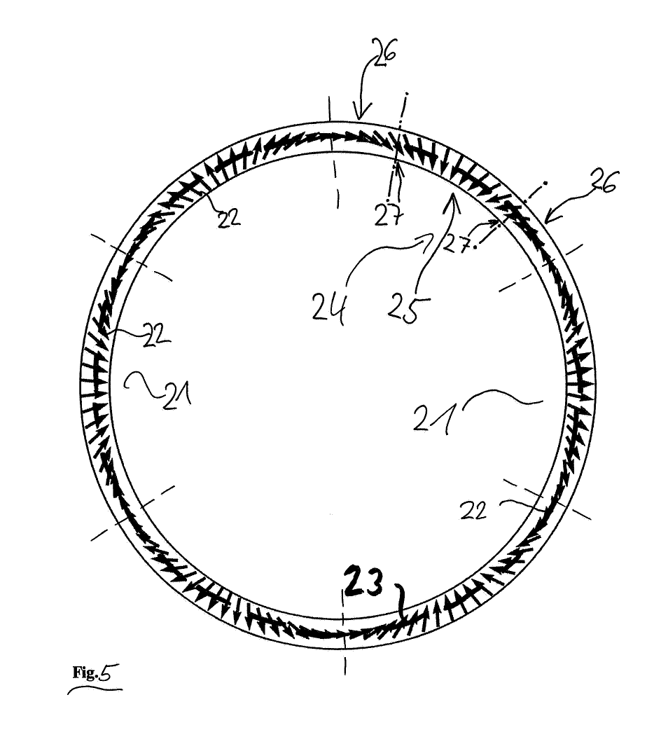

FIG. 4 shows an annular encoder with six poles which is embodied in a conventional way. The magnetization directions 22 of individual areas of the poles 21 are represented by arrows. The poles 21 are magnetized in a homogenous or block-like fashion. The encoders therefore have an alternating north/south magnetization. The arrangement of the poles in series forms, for example, the encoder track.

A magnetic field sensor element (not illustrated) detects, in the close range or when the air gap is relatively small, the block-like or box-profile-like magnetizations of the poles over their homogenous magnetic field. Only when there is a relatively large air gap can the magnetic field sensor arrangement carry out an angular measurement in which the detected angle of the magnetic field rotates with any kind of uniformity along the encoder track, since, when there is a relatively large distance from the encoder track, the magnetic fields of the adjacent and surrounding poles are superimposed on one another. However, a relatively strong magnetic field of the encoder is necessary for this.

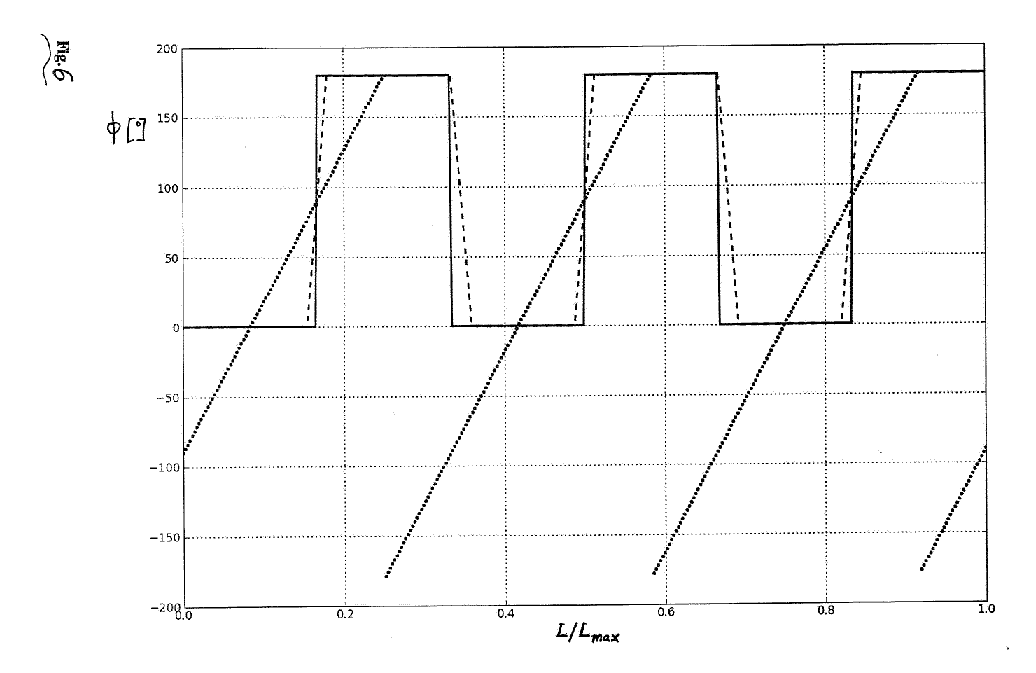

FIG. 5 illustrates an exemplary, annular encoder with magnetization directions 22 which rotate continuously along the encoder track and are illustrated in an individual or exemplary fashion as arrows. The encoder track extends here, for example, along the dashed center line 23 of the ring and is formed by the arrangement of the poles 21 in series. The magnetization of the encoder and of the poles 21 is embodied in such a way that the respective changes in the magnetization directions 22 of adjacent areas of the poles 21 along the encoder track are embodied extending linearly and continuously with respect to the travel length along the encoder track or with respect to the travel length along the dashed center line 23. For this reason, even when there is a relatively short air gap and independently of the air gap length, a magnetic field sensor element (not illustrated) can detect a magnetic field which is embodied in a uniformly rotating fashion along the encoder track, as a result of which radial angular measurement is possible essentially independently of the air gap length.

For example, the magnetization of the poles 21 is explained in more detail on the basis of the pole 24. The pole 24 can be divided into a central segment 25 with 50% of the pole length and two edge segments 26 which bound this central segment 25 and each have 25% of the pole length. Within this central segment 25, the magnetization directions 22 of the areas model a rotation of essentially 90°, which, for example, is implemented in a real encoder as a rotation of 90°±5° due to fabrication inaccuracies. In other words, the magnetization directions 22 of the two outermost areas 27 on each side of the central segment 25 of this pole 24 are embodied rotated by essentially 90° or 90°±5° with respect to one another.

The areas are, for example, actually infinitesimally narrow along the encoder track, but this cannot be represented concretely.

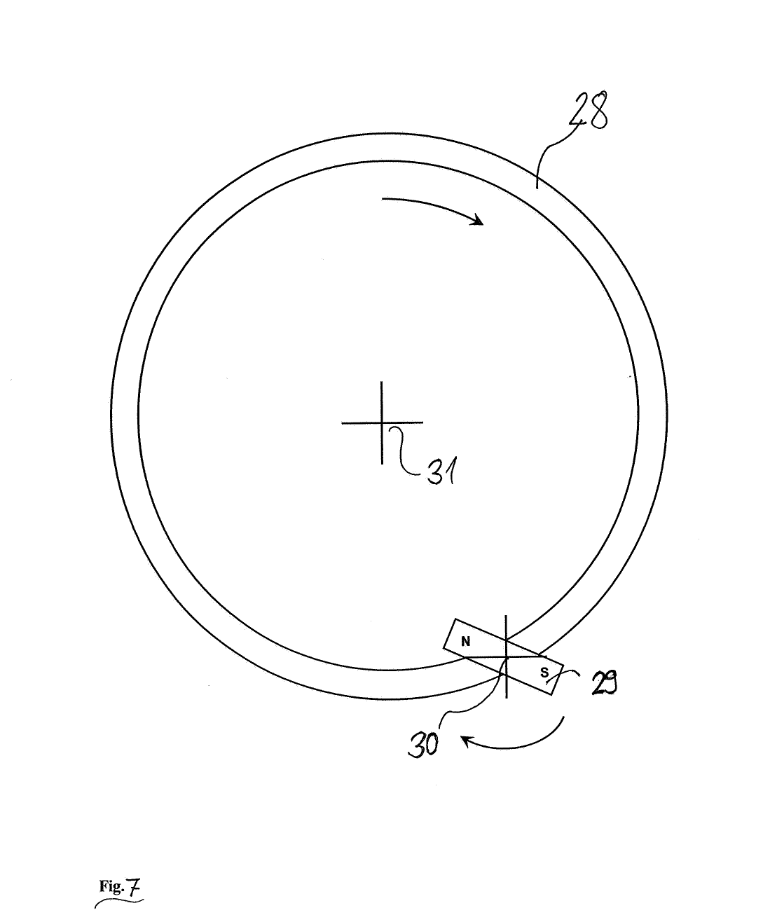

In FIG. 6, for the sake of clarification, the field direction Φ is plotted in degrees against the standardized encoder track length L/Lₘₐₓ, i.e. the measuring variable or the field line profile detected by a magnetic field sensor element along the encoder track, of a sensor arrangement (not illustrated). The continuous curve represents here an encoder which is magnetized in a block-like manner according to the prior art, measured directly on the surface, with the idealization of block-like poles according to FIG. 4. The dashed curve represents the same encoder at the same distance, but taking into account a transition zone which is in reality always present between the poles. The dotted curve represents the field direction profile of an exemplary encoder with magnetization directions which rotate continuously along the encoder track with respect to a relatively freely selectable air gap, as in FIG. 5. This dotted curve also represents the field curve profile, which can be detected by a magnetic field sensor element, of a conventional encoder which is magnetized in a block-like manner in an idealization and with a relatively large air gap.

In FIG. 7, an exemplary magnetization device for manufacturing a magnetic encoder with magnetization directions which rotate continuously along the encoder track is illustrated. The raw encoder 28 or the unmagnetized encoder is mounted about its center 31 in such a way that it can move in rotation in the direction of the associated arrow. The field-generating means 29, embodied for example as a rod-shaped permanent magnet, are rotatably mounted about the axis 30.

For the purpose of magnetization, the two movements are carried out in a coordinated way with respect to one another so that each area of the raw encoder 28 reaches, during its rotation about 31, a point under field-generating means 29 at a time at which the field-generating means 29 are in the suitable angular position. After a complete revolution of the encoder, the magnetization thereof is terminated, for example, according to FIG. 5. For this purpose, the field-generating means 29 carry out precisely three revolutions during the one 360° revolution of the encoder. By means of this method, it is possible to implement slightly different encoders with different pole numbers with the same design. Only the transmission ratio or the relative angular speed of the drives has to be changed, and this can easily be done using stepping motors, for example.

1.-15. (canceled)

16. An angle sensor arrangement for measuring the rotational angle of a shaft having a defined rotational angle measuring range comprising:
a first gearwheel and a first magnetic encoder with at least one encoder track and having one or more pole pairs, wherein the first gearwheel and the first magnetic encoder rotate with the shaft, and
a second gearwheel and a second magnetic encoder with at least one encoder track and having one or more pole pairs, wherein the second encoder rotates with the second gearwheel, and the first and second gearwheels interact, and wherein at least one magnetic field sensor element is assigned to the first encoder and to the second encoder, respectively, wherein the first and second gearwheels are embodied in terms of a common transmission ratio and the first and second magnetic encoders are embodied in terms of their pole numbers in such a way that a first magnetic field sensor element which is assigned to the first or second encoder detects n poles or pole pairs over the entire rotational angle measuring range of the angle sensor arrangement, and a second magnetic field sensor element which is assigned to the other encoder detects n−1+Δ poles or pole pairs over the entire rotational angle measuring range of the angle sensor arrangement, where A is defined as a real number between 0 and 1, and n is defined as a natural number.

17. The angle sensor arrangement as claimed in claim 16, wherein the defined rotation angle measuring range is more than 360°.

18. The angle sensor arrangement as claimed in claim 16, wherein the first and second magnetic field sensor elements are connected directly or indirectly to an electronic control unit which is configured such that an absolute rotational angle (φ) within the rotational angle measuring range is determined directly or indirectly from the first and second magnetic field sensor element output signals.

19. The angle sensor arrangement as claimed in claim 16, wherein the first magnetic encoder is attached to the first gearwheel and wherein the second magnetic encoder is attached to the second gearwheel.

20. The angle sensor arrangement as claimed in claim 19, wherein the first magnetic encoder is concentrically attached to the first gearwheel and the second magnetic encoder is concentrically attached to the second gearwheel.

21. The angle sensor arrangement as claimed in claim 16, wherein the first magnetic encoder is embodied as a multipole encoder, and the second magnetic encoder is embodied as a dipole encoder.

22. The angle sensor arrangement as claimed in claim 16, further comprising a signal processing unit with at least two signal processing channels, wherein the magnetic field sensor element which is assigned to the first encoder is connected to a first signal processing channel, and the magnetic field sensor element which is assigned to the second encoder is connected to a second signal processing channel, wherein the two signal processing channels are connected on the output side to a multiplexer which is connected to an analog/digital converter which is connected on the output side to a calculation unit which calculates in each case a rotational angle (φ₁, φ₂) of the first and second encoders and/or calculates an absolute rotational angle (φ) of the shaft from the rotational angle (φ₁, φ₂) of the first and second encoders.

23. The angle sensor arrangement as claimed in claim 16, wherein Δ is a value greater than 0 and less than 0.5.

24. The angle sensor arrangement as claimed in claim 23, wherein Δ is a value greater than 0 and less than 0.04.

25. The angle sensor arrangement as claimed in claim 16, wherein n is a value between 8 and 60.

26. The angle sensor arrangement as claimed in claim 16, wherein the first encoder is of an annular configuration.

27. The angle sensor arrangement as claimed in claim 16, wherein the first and second gearwheels each have an oblique toothing, and/or wherein the angle sensor arrangement has a third gearwheel which is arranged coaxially with respect to the second gearwheel and, together with the second gearwheel, is meshed with the first gearwheel by means of a spring bias.

28. The angle sensor arrangement as claimed in claim 16, wherein the magnetic field sensor elements are arranged essentially in a common plane in terms of their respective sensitive main planes.

29. The angle sensor arrangement as claimed in claim 16, further comprising a housing which is of an at least partially magnetically screening design.

30. The angle sensor arrangement as claimed in claim 16, wherein the first and/or second magnetic encoders are configured such that the magnetization directions of areas within at least one of the poles change substantially continuously and/or monotonously and/or in a continuously progressive fashion along the encoder track.

31. The angle sensor arrangement as claimed in claim 30, wherein the respective change in the magnetization directions of adjacent areas of one or more poles along the encoder track is embodied substantially linearly with respect to a corresponding change in travel length along the encoder track.

32. The angle sensor arrangement as claimed in claim 30, wherein, at least within the areas in a central segment of a pole which comprises 50% of the pole length along the encoder track and is bounded by two edge segments of this pole comprising in each case 25% of the pole length on both sides, the magnetization directions of these areas in the central segment of this pole essentially model a rotation of at least 45°, and/or wherein the magnetization directions of the two outermost areas on both sides of the central segment of this pole are embodied rotated through at least 45°, with respect to one another, wherein the magnetization directions are always related to the respective profile direction of the encoder track.

33. The angle sensor arrangement as claimed in claim 32, wherein the magnetization directions of the areas in the central segment of the pole essentially model a rotation of at least 70°.

34. The angle sensor arrangement as claimed in claim 32, wherein the magnetization directions of the two outermost areas on both sides of the central segment of this pole are embodied rotated through at least 70°.

35. The use of the angle sensor arrangement as claimed in claim 16 as a steering angle sensor arrangement in a motor vehicle.
